(19) United States
(12) Patent Application Publication
(10) Pub. No.: US 2002/0147964 A1
(43) Pub. Date: Oct. 10, 2002

(54) Method and system for developing a device-independent programming language

(76) Inventors: David G. Cutler, Chicago, IL (US); Jeffrey Palmer, Chicago, IL (US)

Correspondence Address: Timothy M. Morella, BANIAK PINE & GANNON, Suite 1200, 150 N. Wacker Drive, Chicago, IL, 60201, US

(21) Appl. No.: 09/988,857

(22) Filed: Nov. 15, 2001

Related U.S. Application Data
(60) Provisional application No. 60/303,827, filed on Jul. 9, 2001.
(60) Provisional application No. 60/249,068, filed on Nov. 15, 2000.

(51) Int. Cl. G06F 9/44

(52) U.S. Cl. 717/120

(57) ABSTRACT

A method of developing an application utilizing a device-independent programming language is provided. A functionality of a current application is determined. The current application being desired to be accessed via at least one communication device. A device-independent application representation of the functionality of the existing application in the device-independent programming language is defined. Additionally, the device-independent programming language can be interpreted by a system to allow for the generation and transmission of a device-specific programming language for each of the at least one communication devices.

### APPLICATION HISTORY

This Application claims the benefit of U.S. Provisional Patent Application, Serial No. 60/303,827, filed on Jul. 9, 2001 and entitled “System for Providing Multiple Channel Access to a Plurality of Subscribers via an Improved Programming Language,” and U.S. Provisional Patent Application, Serial No. 60/249,068, filed on Nov. 15, 2000 and entitled “Method and System for Providing Multiple Channel Access to a Plurality of Subscribers.”

### FIELD OF THE INVENTION

The present invention relates to the development of extensible markup languages, and, more particularly, a system for providing multiple channel access to a plurality of subscribers via an improved programming language.

### BACKGROUND OF THE INVENTION

The explosive growth in mobile technology and voice recognition software has created tremendous opportunities for companies to interact with subscribers, i.e. software users, in a plethora of ways. A multi-channel approach to application development has become vital to companies seeking to leverage the opportunities of these new technologies and software. As companies scramble to increase their application and mobile offerings, information technology professionals struggle to create usable applications across the multiple standards associated with each particular emerging mobile device. Moreover, companies embarking on multi-channel development are faced with the problem of minimizing the risk of such development in an evolving market, so as to not be required to persistently update their systems, while at the same time, shortening the time necessary to roll out production of applications in order to leverage valuable offerings.

To this end, a paradigm shift is currently occurring in the way developers approach application development. This paradigm shift is occurring because of the proliferation of communication devices that developers, through the programs or applications, must support. Research studies confirm that subscribers (or users or the like) want to utilize the benefits of receiving information using any or all information or communication devices, according to their particular or instant needs. That is, the subscribers wish to be able to access personalized information with the communication device with which they are most comfortable. This requires that compatible, synchronized content be available across all communication channels.

No longer will developers need to be solely concerned with creating programs or applications for a single communication device. Rather, they must create applications not knowing exactly which communication device users will use to access that application, as well as what the particular constraints of that communication device may be. In order to support the needs of users and their desire to use the technology of their choice to accomplish their daily tasks, it is imperative that developers move towards creating multi-channel applications. An example of a multi-channel application is one that is developed with the same content delivered on and optimized for multiple channels. The move from creating single-device applications to multiple-device applications demands innovations in technology, design and development processes.

### SUMMARY OF THE INVENTION

The present invention takes a fresh approach to this growing problem of multi-channel development. Unlike current transitional technologies, the present invention utilizes a software-based platform that offers a long-term approach, defining the ways people interact with information now, and in the future. This platform is based on an approach called interaction-oriented development. The present invention places control of multi-channel development in the developer's hands. Such an approach enables the developer to define how users will use a particular application. A developer defines an application using an application definition language called MAXML (Multi-Channel Access Extensible Markup Language).

MAXML provides the definition of the desired interaction a developer wishes to have with a user. The interaction definitions are independent of business logic, presentation standards and the communication device being used. MAXML also allows the definition of integration points (i.e., invocations) into existing backend systems, as well as a unique method of describing the functionality contained within the backend systems. The invocations define where the business logic and data, for the interactions come from in backend systems. By creating a layer of abstraction between the communication devices and the underlying data, the developer is shielded from the complexities of the various channels and can write a code for an application once and have it accessible on any channel.

Central to the principle of interaction oriented development is an information interaction group. The information interaction group provides detailed research as to how users want information to be organized and presented, as well as how users want to interact with such information. The information interaction group has defined a human-information interaction model. This model defines the common ways users interact with information, regardless of the technology being used. For example, a task such as an address book lookup can be broken into various activities, each activity comprising various interactions. These interactions are not communication device-specific, however they will appear differently on each communication device, depending on the device characteristics. Despite this fact, the underlying framework is the same.

By using this human-information interaction model as a development framework, the present invention gives developers an incredible advantage - the ability to write data code for an application once and have it accessible on any channel. This code then translates into a future solution to multi-channel development. Using the present invention, platform developers need only define in MAXML the types of interactions the application requires. The system then renders the ideal presentation on the given communication device. As the focus of the application on the interactions and not the communication device, the application never needs to be rewritten for new communication devices. Thus, the present invention removes the risks of changing standards and emerging communication devices while allowing for the development of highly usable applications.

To this end, one embodiment of the present invention provides for a method of developing an application utilizing a device-independent programming language. A functionality of a current application is determined. The current application being desired to be accessed via at least one communication device. A device-independent application representation of the functionality of the existing application in the device-independent programming language is defined. Additionally, the device-independent programming language can be interpreted by a system to allow for the generation and transmission of a device-specific programming language for each of the at least one communication devices.

Another embodiment of the present invention provides for a system for developing an application utilizing a device-independent programming language. A functionality of a current application is determined by a determining means. The current application being desired to be accessed via at least one communication device. A device-independent application representation of the functionality of the existing application in the device-independent programming language is defined by a defining means. Additionally, the device-independent programming language can be interpreted by a system to allow for the generation and transmission of a device-specific programming language for each of the at least one communication devices.

Finally, another embodiment provides for a device-independent programming language. The device-independent programming language comprises a device-independent application representation. The device-independent application representation is related to a task to be implemented between an electronic application and at least one communication device. Additionally, the device-independent programming language can be interpreted by a system to allow for the generation and transmission of a device-specific programming language for each of the at least one communication devices.

### BRIEF DESCRIPTION OF THE DRAWINGS

FIG. 1 is a block diagram of a human-information interaction model, in accordance with the present invention;

FIG. 2 is an example of an application of FIG. 1; and

FIG. 3 is an operational flow chart of the method and system for developing a device-independent programming language, in accordance with the present invention.

### DETAILED DESCRIPTION OF THE PRESENTLY PREFERRED EMBODIMENTS

The present invention provides for a method and system for creating a standardized, or universal, electronic communication language to be used by a plurality of communication devices. One preferred method to realize this goal is through the creation of a device-independent application definition language. This is preferably accomplished through the use of an XML-based (extensible markup language) language, such as, for example, a Multiple-channel Access XML (MAXML). Whether the preferred embodiment of the present invention develops and utilizes MAXML as the device-independent application definition language, or the present invention provides for the development of additional universal device-independent application definition languages, the communication, or programming, language used within the tenets of the present invention goes beyond simply enabling information presentation.

Rather, the communication, or programming, language developed and utilized as a result of the present invention allows a developer (or programmer) to define user interactions with data loosely coupled with presentation and underlying data representation, regardless of the communication device on which the language is to be used, rather than on a communication device-specific basis. In other words, the communication, or programming, language developed herein is device-independent. Through the approach of the method and system of the present invention, the issue of user interaction becomes much more than just user interface design or manipulation of data within the confines of one communication device and that particular communication device's limiting characteristics. Rather, the communication language developed herein is based on a human-information interaction model. This human-information interaction model explains the relationships between data, both presentation and representation, how people interact with that data, and how that data is manipulated within the development process of an application.

Additionally, the communication language of the present invention enables developers (i.e., programmers) to develop a single, universal programming language, or source code, for one application and have that same source code instantly accessible via a multitude of informational, or communication, devices; each of the communication devices using any one of currently- or future-known markup, as well as other programming, languages. As a result, developers need not worry about learning or programming in a specific markup, or other, language associated with a particular communication device. Rather, developers may instead concentrate on developing one source code without concern for changing standards and ever-changing technologies; the communication language itself possesses the ability to conduct such interfacing aspects in line with any changing standards and ever-changing technologies.

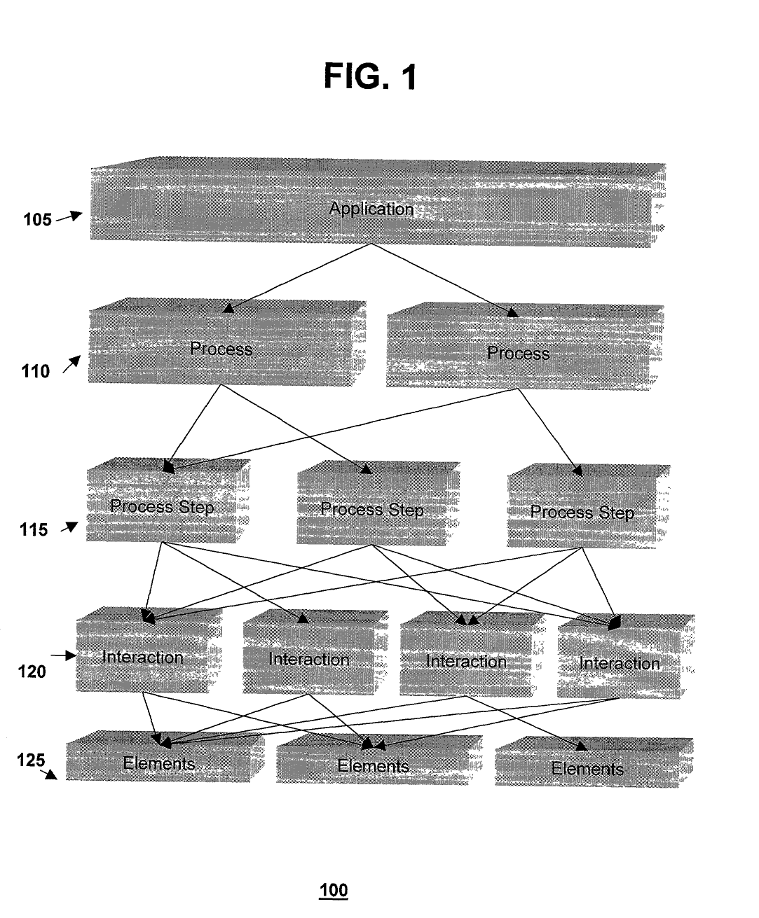

Essentially, MAXML is preferred as the programming language because it is based on a human-information interaction model of performance and operation. The advantages of a human-information interaction model lie in the fact that the way people interact with information does not change based on the technology being used. Through rounds of usability sessions, the present invention takes into account studies of how people interact with a particular application. Research from those studies serves as the basis for the development of the programming language of the present invention, as well as the creation of the human-information interaction model. An example of this model is illustrated in FIG. 1.

Referring to FIG. 1, there is illustrated a top-level block diagram of a human-information interaction model 100, taking into account the language developed in the present invention. As can be seen, human-information interaction model 100 is a hierarchical system, descending gradually downwards into levels more detailed than the previous levels. Moreover, as should be understood, the collection of the aspects of a level below (process steps, for instance) coalesce to form the level above (processes). That is, for example, each process has one or more process steps. The collection of all the process steps for a particular process coalesce to realize the goal of the process.

Generally speaking, at the top of human-information interaction model 100 there is an application 105. Application 105 preferably comprises an upper level of human-information interaction model 100 and represents one “task” that must be completed. The next level in human-information interaction model 100 are processes 110. Processes 110 preferably represent the next level in human-information interaction model 100, and are the next most-detailed aspect. Essentially, processes 110 are the framework of an algorithm or program to which the developer wishes to have performed, and which, together with other processes, achieves the result of application 105. Processes 110 are made up of a number of process steps 115. Within process steps 105 are interactions 120. Interactions 120, which are related to the performance of the application, are aspects of process steps that the system running the programming language developed herein utilizes to achieve the broad goal of the application (i.e., fill the entries of an address book). Finally, each interaction 120 is made up of at least one element 125. Elements 125 are the building blocks of the MAXML language.

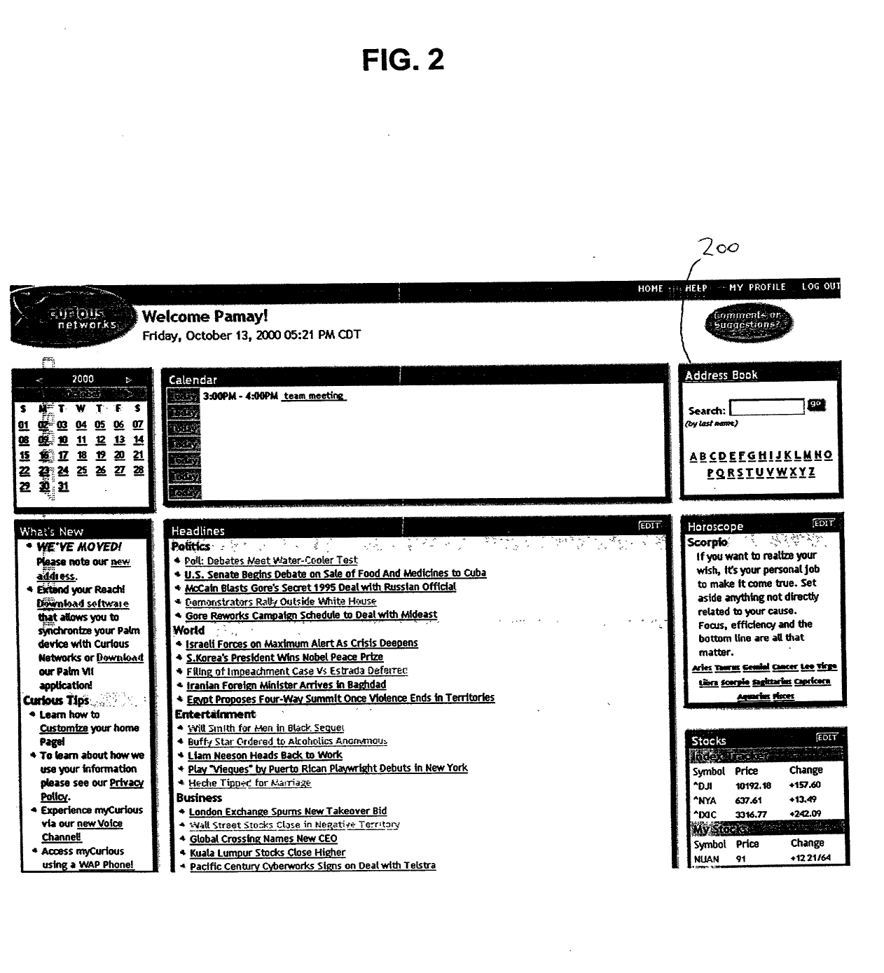

Thus it is that human-information interaction model 100 forms the basis of MAXML. Human-information interaction model 100 explains the relationship between the many important pieces of the multi-channel application puzzle. Processes 110, which are near the top of human-information interaction model 100, may be defined as any specific implementation that serves a particular purpose for a user. One example of a process is a portal. A portal is an application that serves the purpose of aggregating the important information that a user refers to on a daily basis, such as, for example, a portal to an Internet, or World Wide Web, site. An example of such a portal is shown in FIG. 2.

Referring again to FIG. 1, a plurality of process steps 115 make up each process 110. Process steps 115 provide a map to the real world activities for which people utilize technology (i.e., portlets). To use the portal example in FIG. 2, above, process steps that are visible are the calendar, the “Day at a Glance,” the address book, what's new, headline news and horoscope. These process steps map to real world activities used by various users, such as maintaining contacts, tracking appointments, tracking financial or keeping up with current events.

Referring again to FIG. 1, interactions 120 represent the most common way that people manipulate information in order to accomplish specific tasks and goals. Each process step 115 as shown in FIG. 1, breaks down into a number of specific interactions 120. Once interactions 120 have been identified, developers can use these interactions to augment their development effort, or application. The architecture of the software of the present invention is able to interpret these interactions 120 in an effort to intelligently create the appropriate interface for the communication device in use. Interactions 120 are important because they are not situation-specific or communication device-specific. Rather, they outline the common ways in which users interact with information, regardless of the delivery mechanism that is being used. This is important in the development of processes 110 and process steps 115 that will be delivered via a variety of communication devices that have different interface characteristics and constraints.

For example, the address book activity that is part of the portal shown in FIG. 2 at reference numeral 200 provides many ways in which a user may interact with an application; in this case, an address book or a contact manager. Such users may add a new contact, delete a contact, edit a contact or search the database for some specific contact information. All of these interactions map to interactions 120 that are part of human-information interaction model 100.

The type of interaction that appears in the portal application illustrated in FIG. 2 utilizes the idea of a collection. Information frequently comes packaged in “collections.” These collections may be certain kinds of tables, lists, trees or other types of information clusters. Generally, users interact with collections by creating them, adding to them, editing them, updating them and viewing detail associated with an element within the collection. In the portal application that is shown in FIG. 2, the stock portfolio application is another example of an activity that utilizes a collection-based interaction. Users can manage this particular collection by creating new portfolios and adding new stocks to those portfolios. Users may also display detail associated with each member of the collection, as well as searching for information related to the collection. All of these collection manipulations can be categorized as different interactions.

Referring again to FIG. 1, elements 125 are the building blocks of the MAXML language. A family of elements 125 forms a strong foundation upon which development can take place. The group of elements 125 serves as a strong foundation upon which human-information interaction model 100 rests.

Additional information regarding the MAXML language may be found in the material enclosed in Appendix A, the contents of which are hereby incorporated herein in its entirety. More specifically, Appendix A includes an index of tags used within the MAXML programming language.

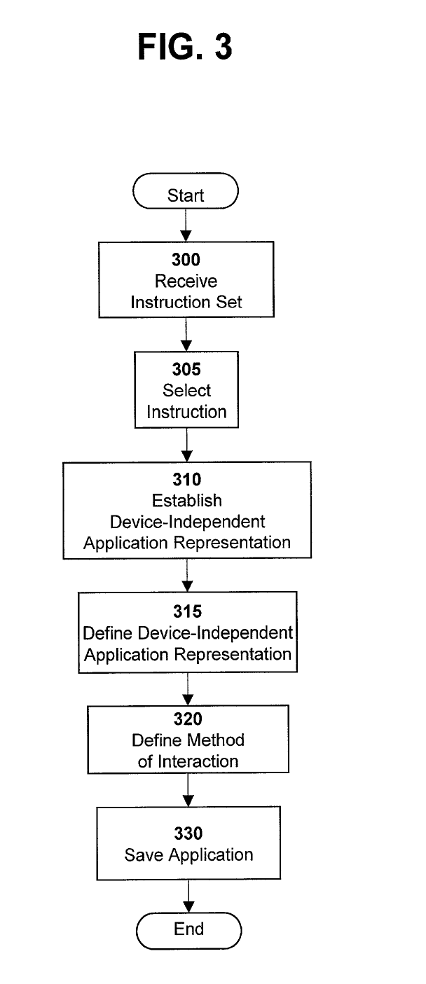

The following paragraphs describe the overall process of developing a device-independent programming, or communication, language in accordance with the present invention. For purposes of the present invention, as well as the example below, the programming language used herein will be the MAXML language, as described above. Moreover, for illustrative purposes, the process of developing the MAXML language described herein is illustrated via the flow chart of FIG. 3.

In Step 300 of FIG. 3, an instruction set is received. Preferably, a developer or programmer receives the set of instructions. The instruction set comprises a set of instructions (from an existing application) to be implemented between an application and a communication device. The receipt of the instruction set allows the functionality of the existing application to be determined. For purposes of the present invention, an application is defined as a site on the World Wide Web (i.e., an Internet page). Moreover, a communication device, for purposes of the present invention, is preferably defined as an electronic communication device capable of electronically communicating with and receiving communications from an application. Such examples of communication devices include, without limitation, wireline telephones, mobile telephones, paging units, radio units, wireless data devices, World Wide Web telephones, portable or wireless telephones, personal information managers, personal digital assistants, personal computers, network televisions, Internet televisions, Internet telephones, portable wireless devices (i.e., two-way pagers), security systems (both mobile and premises-based), workstations, automobile telematics systems or any other suitable communication device.

Each communication device may also operate according to the tenets of an operating or programming language. For purposes of the present invention, an operating language is defined as a language guiding the operation of the communication device. Such examples of an operating language are HyperText Markup Language, Wireless Markup Language and Voice Markup Language.

As mentioned above, the instruction set comprises a set of instructions to be implemented between an application and a communication device. That is, the instruction set is preferably an encapsulated, top-level description of a task to be completed vis a vis an application and a communication device. For example, the instruction set may be a directive to input an address into an address book. More specifically, the set of instructions may include, for example, the following list:

Open an address book application;

Log on to the application, if necessary;

Request to add an address entry to the application;

Be prompted for information relating to fields of entry, such as, for example, name, address, telephone number, email address;

Input the requested-for information;

Review the application;

Approve the application; and

Log off the application, if necessary.

Throughout this discussion, the above example will be used for illustrative purposes.

In Step 305 of FIG. 3, one of the instructions contained within the instruction set is selected. Preferably, the instruction is selected in order, but such is not necessarily the case. Using the illustration above, the opening step may be the selected instruction. At this point, the selected instruction will undergo the steps discussed below to develop an application according to the MAXML language. Once completed, the next instruction (i.e., the requesting step) will be selected, and manipulated (i.e., developed according to the parameters of the programming language of the present invention) in much the same way. This process preferably continues until all instructions contained within the instruction set are manipulated accordingly.

As illustrated by Step 310 of FIG. 3, for each existing application, a device-independent application representation is established. For purposes of this step, an application comprises a top-level indicator of a “translation” of the selected instruction in MAXML code. Thus, the device-independent application representation corresponds to the selected instruction. Using the above example, a device-independent application representation may be established for opening the address book, for logging onto the address book, for requesting to add an entry to the address book, etc.

Once the device-independent application representation has been established, additional device-independent application representations will be defined. The device-independent application representations are based on fulfilling the implementation of the functionality of the existing application. Additionally, the device-independent application representations are based on the human-information interaction model of communication, described above. The defining of the device-independent application representations are illustrated generally in Step 315 of FIG. 3, and discussed in detail below.

Next, a process is defined. Preferably, the act of defining a process may comprise the steps of (1) determining a particular application to be created, (2) determining the activities to be performed as part of that application and (3) determining the interactions that make up those activities. That is, a developer, in defining the process for the selected instruction, essentially will define an algorithm or program to which the developer wishes to have performed, and which achieves the task of the selected instruction. In essence, defining the process allows the developer to set forth the framework which will become a “manipulated” selected instruction. That is, the selected instruction will be developed in terms of the programming language of the present invention. Thus, the defining of the process is preferably accomplished through the use of the programming language of the present invention to create the desired application; i.e., MAXML in this case. Doing so, in accordance with the objects of the present invention, will allow the defined process to be used by any communication device, regardless of the particular language that that particular communication device in fact uses.

Using the example above, in this step, each of the set of the generic instructions, listed above, will be defined, or developed, in accordance with the programming language of the present invention. That is, the tasks to be performed by each generic instruction will be rewritten in the programming language developed herein. So, for example, if the selected generic instruction is the prompting step, the basic framework of a prompting step (i.e., a second level) will be developed (i.e., the defining of what is to be performed or created).

Next, the developer then defines at least one process step for each of the processes. That is, after laying the framework for each process, as illustrated above, the developer then begins to further structure the process in a more detailed manner, by inserting various third-level steps that will take place between the application and a user.

Using the example of the address book, as described above, the developer may insert various request commands, or directives, such as, for example, “get information related to address book” and “validate information related to address book.” In this way, the developer will program into the process step various aspects of the process which relate to the gathering or validation of information from the user.

Next, the developer may then define a plurality of interactions to support each of the process steps, as defined above. That is, after laying the framework for the process steps, the developer then begins to further structure the application in a more detailed, i.e., fourth-level, manner, by defining various interactions related to the performance of the application. For example, using the address book example discussed above, the developer may define the following non-exhaustive list of interactions: (1) establish a name field; (2) establish an address field; (3) establish a telephone number field; (4) establish an email address field; and (5) input information into fields. In any event, the specific aspects of each of these interactions are referred to as elements. Such elements include, using the example of a name field, the following: (1) open a field; (2) entitle the field as a name field; (3) allow for three sub-fields within the field; (4) entitle the sub-fields as first name, middle name and surname; and (5) allow for 15 characters in each sub-field.

In come cases, the MAXML-developed application may need to “call” back to a back-end system to obtain or transfer information. This process of calling back is referred to as an invocation. Thus, using the name example, once the user has entered his first, middle and surnames, and the programming language wished to perform a search to either validate the information or check for redundancy, a server, or other entity, running the programming language would call an invocation, pass the date to the application and wait for a response. In certain cases, data may be passed from the application to the server, or other entity, running the programming language. In such a case, the invocation call would be made, and the data would be transferred from the application. Such invocation calls may occur at any time during the development of the device-independent programming language.

Next, as illustrated in Step 320 of FIG. 3, the developer then defines a method for interaction between the application and a user. In this step, the developer compiles and records a preferred list of methods of interaction. That is, the system interpreting, or running, the programming language, or MAXML, may, for example, direct the device-independent process definition to use a graphical-user interface, a data-user interface or a voice-user interface in an effort to obtain the information contained within the invocations from the user.

For example, when obtaining the personal information (i.e., name, address, contacts) necessary to create an address book entry, the process may be interpreted by the system operating the programming language to prompt the user via a voice-user interface, in which the application transmits a voice signal, in effect asking the user for information. Additionally, the communication device may be prompted by the system interpreting the programming language to graphically display the request, such as on a computer screen. Of course, the method of interaction between the user and the application would be dependent upon the communication device, as not all devices possess all types of interfaces.

Finally, the system interpreting, or running, the programming language just developed may preferably save the application in a memory location. This step is illustrated in Step 330 of FIG. 3. Alternatively, the application may be stored in a currently- or future-known method of diskette storage.

Upon setting up and utilizing the programming language of the present invention, and in conjunction with the flexibility and uniqueness of the MAXML language, the developer has now just completed a device-independent process definition, in MAXML, that will be able to be understood by communication devices using any number of currently-known and/or future-known markup, or other, languages.

Mention has been made about the system interpreting the programming language of the present invention. One example of such a system is the system referenced in U.S. Non-Provisional patent application Ser. No. ______, filed concurrently herewith on Nov. 15, 2001, and entitled “Methods and System for Providing Multiple Channel Access from a User Device to an Application,” the contents of which are hereby incorporated herein in their entirety.

It should be appreciated that the embodiments described above are to be considered in all respects only illustrative and not restrictive. The scope of the invention is indicated by the following claims rather than by the foregoing description. All changes that come within the meaning and range of equivalents are to be embraced within their scope.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A method of developing an application utilizing a device-independent programming language, comprising:
determining a functionality of an current application, the current application being desired to be accessed via at least one communication device; and
defining a device-independent application representation of the functionality of the current application in the device-independent programming language;
wherein the device-independent programming language can be interpreted by a system to allow for the generation and transmission of a device-specific programming language for each of the at least one communication devices.

2. The method of claim 1, wherein the step of defining the device-independent application representation further comprises:
defining at least one process, each of the at least one processes detailing a task to be completed in accordance with the device-independent application representation;
for each of the defined processes, defining at least one process step, each of the at least one process steps combining to realize the defined process;
for each of the defined process steps, defining at least one user interaction, each of the at least one user interactions combining to realize the defined process step; and
for each of the defined user interactions, defining at least one element, each of the at least one elements combining to realize the defined interactions.

3. The method of claim 2, further comprising storing the device-independent application representation and allowing the memory location to be accessed.

4. The method of claim 1, wherein the current application corresponds to a set of functionality to interact with an electronic application and one of the at least one communication devices.

5. The method of claim 1, wherein each of the at least one communication devices includes a device presentation language.

6. The method of claim 1, further comprising performing an invocation call to a back end system to access the functionality of the back end application.

7. The method of claim 6, further comprising transferring data contained within the device-independent application representation, received from the communication device, to the back end system.

8. The method of claim 6, further comprising receiving data from the back end system containing the device-independent application representation.

9. The method of claim 1, wherein the device-independent programming language is an extensible markup language (XML).

10. The method of claim 1, wherein the device-independent programming language is a multiple-channel access extensible markup language (MAXML™).

11. The method of claim 1, wherein the device-independent application representation corresponds to a human-information interaction model.

12. A system for developing an application utilizing a device-independent programming language, comprising:
means for determining a functionality of an current application, the current application being desired to be accessed via at least one communication device; and
means for defining a device-independent application representation of the functionality of the current application in the device-independent programming language;
wherein the device-independent programming language can be interpreted by a system to allow for the generation and transmission of a device-specific programming language for each of the at least one communication devices.

13. The system of claim 12, wherein the means for defining the device-independent application representation further comprises:
means for defining at least one process, each of the at least one processes detailing a task to be completed in accordance with the device5 independent application representation;
for each of the defined processes, means for defining at least one process step. each of the at least one process steps combining to realize the defined process;
for each of the defined process steps, means for defining at least one user interaction, each of the at least one user interactions combining to realize the defined process step; and
for each of the defined user interactions, means for defining at least one element, each of the at least one elements combining to realize the defined interactions.

14. The system of claim 13, further comprising means for storing the device-independent application representation and means for allowing the memory location to be accessed.

15. The system of claim 12, further comprising means for performing an invocation call to a back end system to access the functionality of the back end application.

16. The system of claim 17, further comprising means for transferring data contained within the device-independent application representation, received from the communication device to the back end system.

17. The system of claim 17, further comprising means for receiving data from the back end system containing the device-independent application representation.

18. The method of claim 1, wherein the device-independent application representation corresponds to a human-information interaction model.

19. A device-independent programming language, comprising:
a device-independent application representation, the device-independent application representation being related to a task to be implemented between an electronic application and at least one communication device;
wherein the device-independent programming language can be interpreted by a system to allow for the generation and transmission of a device-specific programming language for each of the at least one communication devices.

20. The method of claim 1, wherein the device-independent application representation corresponds to a human-information interaction model.
